(19) United States
(12) Patent Application Publication
(10) Pub. No.: US 2008/0303950 A1
(43) Pub. Date: Dec. 11, 2008

(54) VIDEO SIGNAL RECEIVING CIRCUIT

(76) Inventors: Chun-Chih Hou, Tainan County (TW); Hung-Sung Li, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/045,681

(22) Filed: Mar. 10, 2008

Related U.S. Application Data
(60) Provisional application No. 60/941,955, filed on Jun. 5, 2007.

(51) Int. Cl. H04N 5/00

(52) U.S. Cl. 348/607; 348/E05.001

(57) ABSTRACT

A circuit for reducing ground noise of video signals is provided. The circuit includes a current source, a plurality of resistors, an AC coupling circuit and a subtracting circuit. The resistors are used for outputting a first and second voltage levels corresponding to different voltages provided by the series-connected resistors. The AC coupling circuit is used for receiving a reference ground signal and coupling an AC component of the reference ground signal to generate the reference voltage level. The subtracting circuit is used for subtracting the first and second voltage levels from two video signals, respectively.

### CROSS REFERENCE TO RELATED APPLICATIONS

This application claims the provisional application, which is U.S. Provisional Application No. 60/941,955, filed Jun. 5, 2007, and is included herein by reference.

### BACKGROUND OF THE INVENTION

The present invention relates to a video signal receiving circuit, and particularly relates to a circuit and method of providing specific voltage levels for respectively processing video signals.

FIG. 1 is a schematic diagram illustrating part of a prior art video signal receiving circuit. In a video signal processing system, such as an analog TV system, an S-video signal generally comprises a C-signal (chrominance signal) and a Y-signal (luminance signal), where the C-signal and Y-signal are transmitted through different channels 101 and 103 respectively of a transmission cable, for example, as shown in FIG. 1. Also, the Y-signal and C-signal are referred to a reference ground RG in the transmitter end. In the receiver end, the reference ground RG transmitted through the transmission cable may have low frequency noise due to a long cable transmission. Therefore, this noise has to be canceled from both of the C-signal and Y-signal. However, the C-signal and Y-signal may have different DC levels that go against the cancellation involving only a simple reference ground.

Thus, it is needed to solve this problem.

### SUMMARY OF THE INVENTION

One objective of the present invention is to provide a video signal receiving circuit and method for providing required voltage levels for video signals, such that the video signals can be processed with their corresponding correct voltage levels.

One embodiment of the present invention discloses a circuit for reducing ground noise of video signals. The circuit includes a current source, a plurality of resistors, an AC coupling circuit and a subtracting circuit. The resistors are used for outputting a first and second voltage levels corresponding to different voltages provided by the series-connected resistors. The AC coupling circuit is used for receiving a reference ground signal and coupling an AC component of the reference ground signal to generate the reference voltage level. The subtracting circuit is used for subtracting the first and second voltage levels from two video signals, respectively.

Another embodiment of the present invention discloses a method for reducing ground noise of video signals. The method includes: receiving a reference ground signal; coupling an AC component of the reference ground signal to generate a reference voltage level; providing a first and second voltage levels corresponding to voltages of different values generated with reference to the reference voltage level; and subtracting the first and second voltage levels from two video signals to obtain two subtracted video signals, respectively.

According to the above-mentioned embodiments, correct voltage levels can be provided to different video signals respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating part of a prior art video signal receiving circuit.

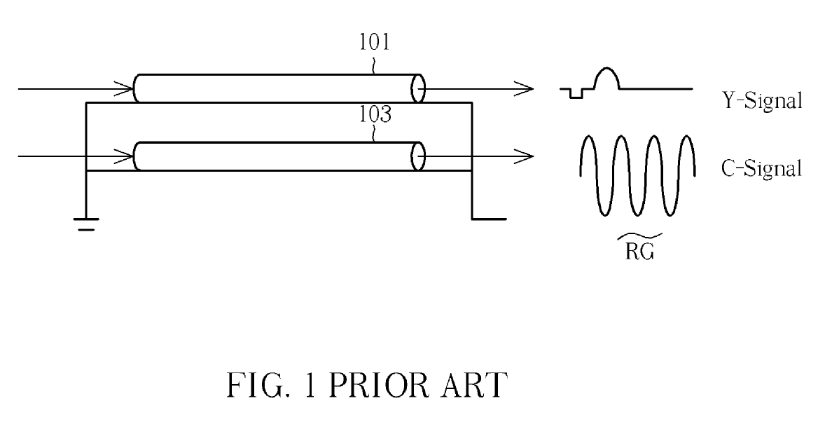

FIG. 2 is a circuit diagram illustrating a video signal receiving circuit according to a first embodiment of the present invention.

FIG. 3 is a circuit diagram illustrating a video signal receiving circuit according to a second embodiment of the present invention.

FIG. 4 is a circuit diagram illustrating a first embodiment of the AC coupling circuit shown in FIG. 2 and FIG. 3.

FIG. 5 is a circuit diagram illustrating a second embodiment of the AC coupling circuit shown in FIG. 2 and FIG. 3.

FIG. 6 is a circuit diagram illustrating a third embodiment of the AC coupling circuit shown in FIG. 2 and FIG. 3.

FIG. 7 is a circuit diagram illustrating a fourth embodiment of the AC coupling circuit shown in FIG. 2 and FIG. 3.

FIG. 8 is a circuit diagram illustrating a fifth embodiment of the AC coupling circuit shown in FIG. 2 and FIG. 3.

FIG. 9 is a circuit diagram illustrating an embodiment of the controllable voltage providing circuit shown in FIG. 7 and FIG. 8.

FIG. 10 is a circuit diagram illustrating another embodiment of the controllable voltage providing circuit shown in FIG. 7 and FIG. 8.

FIG. 11 is a flow chart of a method for reducing ground noise of video signals according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean, “include, but not limited to . . . ” Also, the term “couple” is intended to mean either an indirect or direct electrical connection. Accordingly, if one device is coupled to another device, that connection may be through a direct electrical connection, or through an indirect electrical connection via other devices and connections.

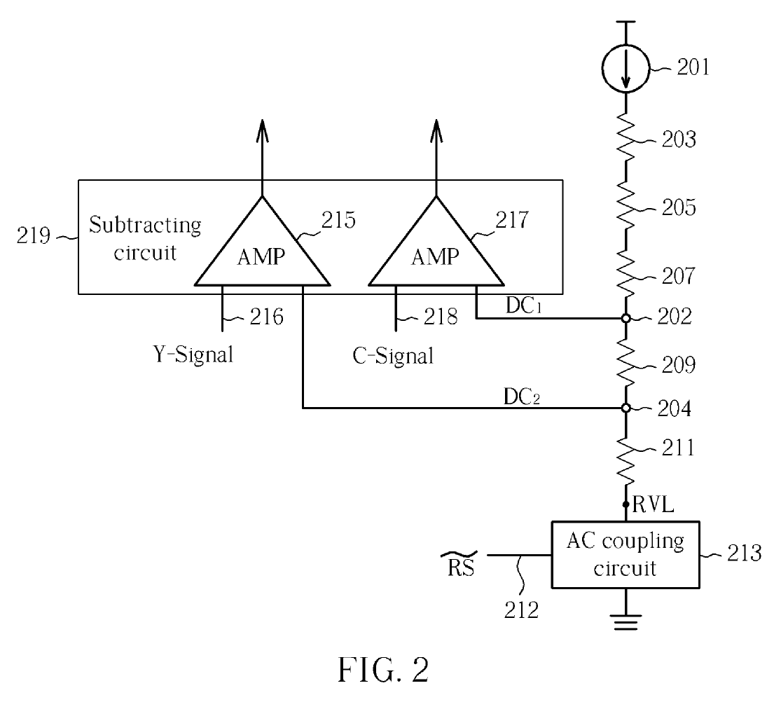

FIG. 2 is a circuit diagram illustrating a video signal receiving circuit 200 according to a first embodiment of the present invention. As shown in FIG. 2, the video signal receiving circuit 200 comprises: a current source 201, a plurality of resistors 203, 205, 207, 209, 211 and an AC coupling circuit 213. The current source 201 is used for providing a predetermined current. The resistors 203, 205, 207, 209 and 211, which are coupled between the current source 201 and a reference voltage level RVL in series, are used for outputting at least one required voltage level from at least one specific connection node of the series-connected resistors 203, 205, 207, 209 and 211. The AC coupling circuit 213, which is coupled to one end of the series-connected resistors 203, 205, 207, 209, 211, is used for receiving a reference ground signal RS, for example, from a wire 212 of a transmission cable and coupling the AC component of the reference ground signal RS to generate the reference voltage level RVL. In this case, one inputs of an amplifier (AMP) 215 and an amplifier 217 are used for receiving the Y-signal and the C-signal, and the other inputs of the amplifier 215 and the amplifier 217 are used to receive the required voltage levels corresponding to the Y-signal and the C-signal respectively. The required voltage levels, e.g. the first and second voltage levels DC₁ and DC₂, can be provided from the connection nodes 202 and 204 of the series-connected resistors 203, 205, 207, 209 and 211. The amplifiers 215 and 217 can be regarded as a subtracting circuit 219 to subtract the first and second DC voltages levels DC₁ and DC₂ from two video signals, such as TV signals (Y-signal and C-signal) received from wires 216 and 218 of the transmission cable. Also, the subtracting circuit 219 can have other suitable devices as well as the amplifiers 215 and 217.

According to this structure, the reference ground signal RS is ac-coupled to a resistor string comprising a plurality of resistors 203, 205, 207, 209 and 211, and the ac magnitude in every connection node between two resistors is approximately equal due to the high-impedance of the current source 201. Then, the noise of the reference ground signal RS is subtracted from the video signals of different DC-levels through amplifiers 215 and 217.

It should be noted that the number of resistors is not limited to the number shown in FIG. 2, and the required voltage levels for different video signals are not limited to be provided from the connection nodes 202 and 204.

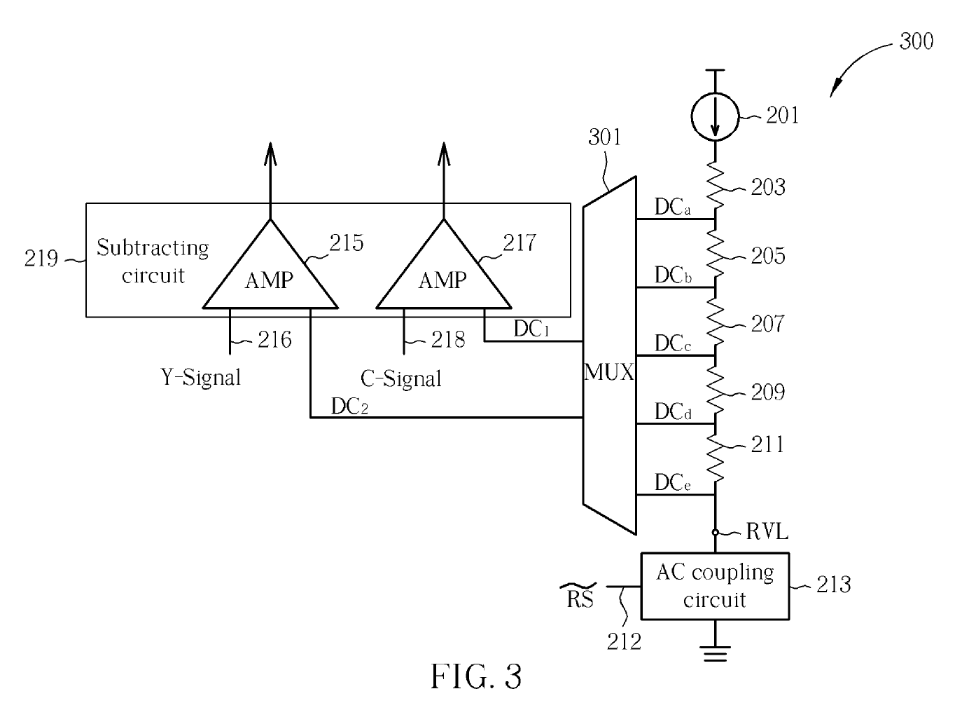

FIG. 3 is a circuit diagram illustrating a video signal receiving circuit 300 according to a second embodiment of the present invention. As in the video signal receiving circuit 300, the video signal receiving circuit 300 also comprises a current source 201, a plurality of resistors 203, 205, 207, 209, 211 and an AC coupling circuit 213. The difference between the video signal receiving circuit 200 and the video signal receiving circuit 300 is that the video signal receiving circuit 300 further comprises a multiplexer 301 coupled between the series-connected resistors 203, 205, 207, 209, 211 and the subtracting circuit 219, e.g. the amplifiers 215 and 217. Therefore, the required voltage levels DC₁ and DC₂ can be selected from a plurality of candidate voltage levels DCₐ, DC_{b}, DC_{c}, DC_{d} and DCₑ provided by the connection nodes between two resistors by the multiplexer 301 instead of are directly provided from two specific connection nodes between the resistors 203, 205, 207, 209 and 211. The operation of other devices of the video signal receiving circuit 300 is similar to that of the video signal receiving circuit 200, thus a related description is omitted for brevity.

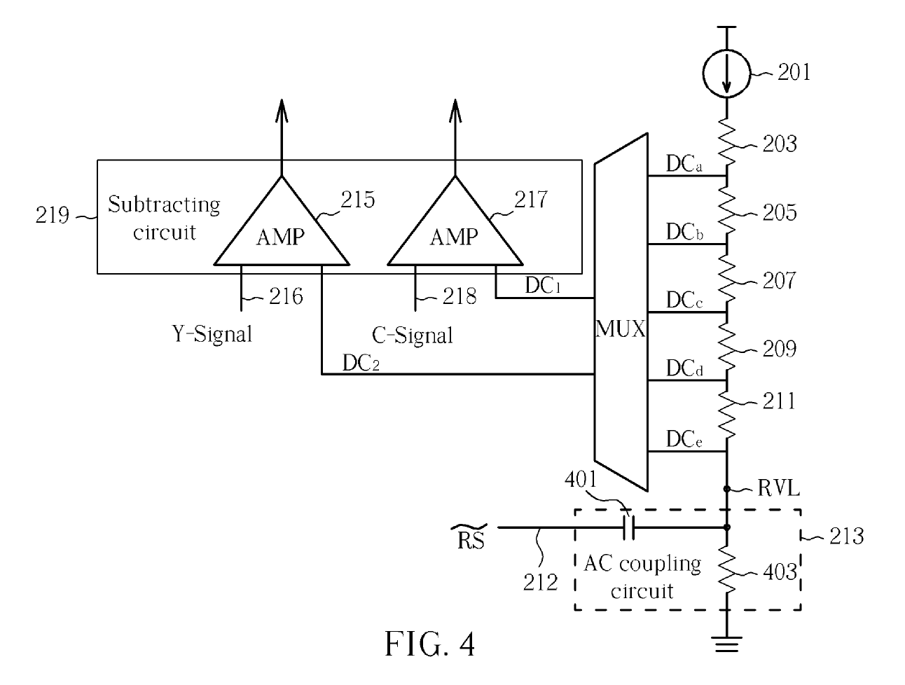

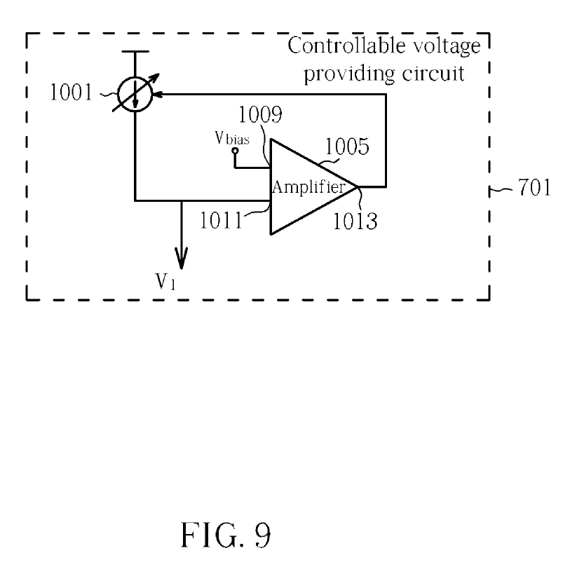

Some embodiments of the detailed structures of the AC coupling circuit 213 are described in FIG. 4 FIG. 9, but do not limit the scope of the present invention. It should be noted that the detailed structures of the AC coupling circuit 213 shown in FIG. 4 FIG. 9 are applied to the structure shown in FIG. 3, but they can be also applied to the structure shown in FIG. 2.

FIG. 4 is a circuit diagram illustrating the first embodiment of the AC coupling circuit 213 shown in FIG. 2 and FIG. 3. As shown in FIG. 4, the AC coupling circuit 213 comprises a capacitor 401 and a resistor 403. That is, the AC coupling circuit 213 can be a RC circuit. The capacitor 401 is coupled between the reference voltage level RVL and the reference ground signal RS. The resistor 403 is coupled between the reference voltage level RVL and a predetermined voltage level (for example, a ground level).

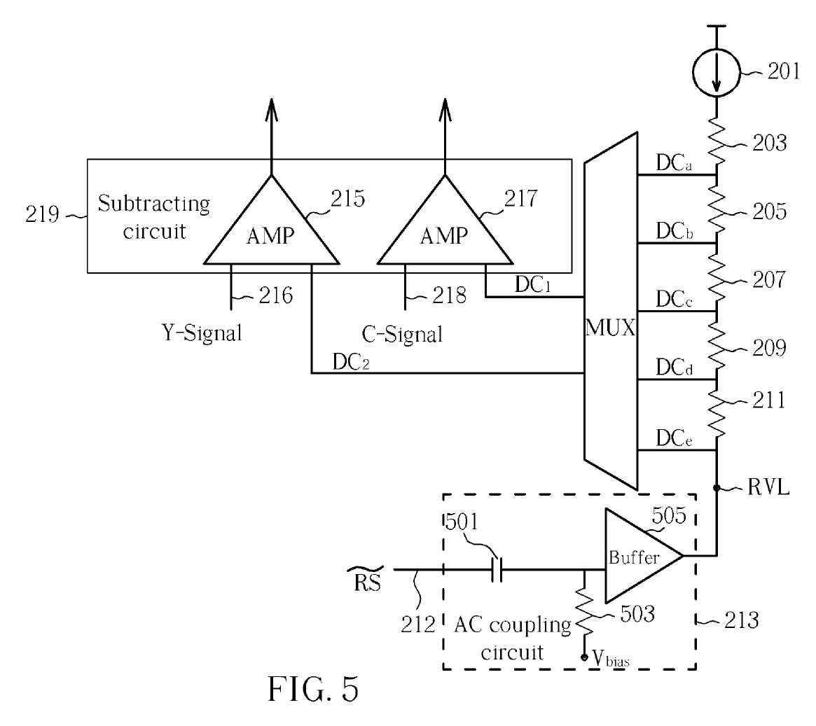

FIG. 5 is a circuit diagram illustrating the second embodiment of the AC coupling circuit 213 shown in FIG. 2 and FIG. 3. In this case, the AC coupling circuit 213 comprises a capacitor 501 and a resistor 503, and the resistor 503 is coupled to a bias voltage level V_{bias}. The AC coupling circuit 213 shown in FIG. 5 further comprises a buffer 505 coupled to the resistor 503 such that the reference ground signal RS is ac-coupled to an input of the buffer 505.

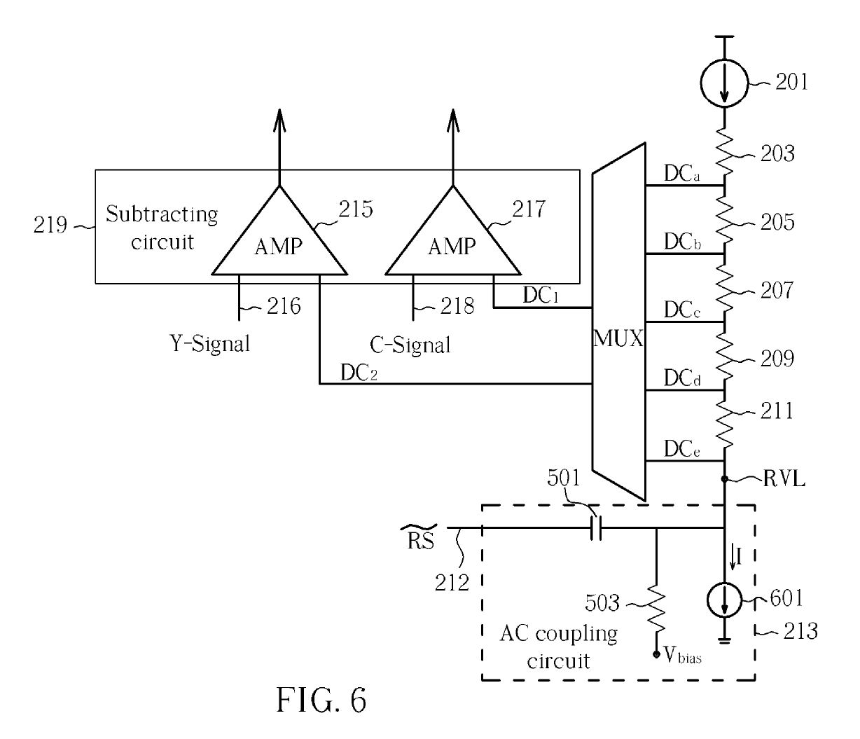

FIG. 6 is a circuit diagram illustrating the third embodiment of the AC coupling circuit 213 shown in FIG. 2 and FIG. 3. As shown in FIG. 6, a current source 601 coupled in parallel to the resistor 503 provides a current 1. According to this circuit, the reference voltage level RVL is determined by the values of the bias voltage level V_{bias}, the current 1, and the resistor 503.

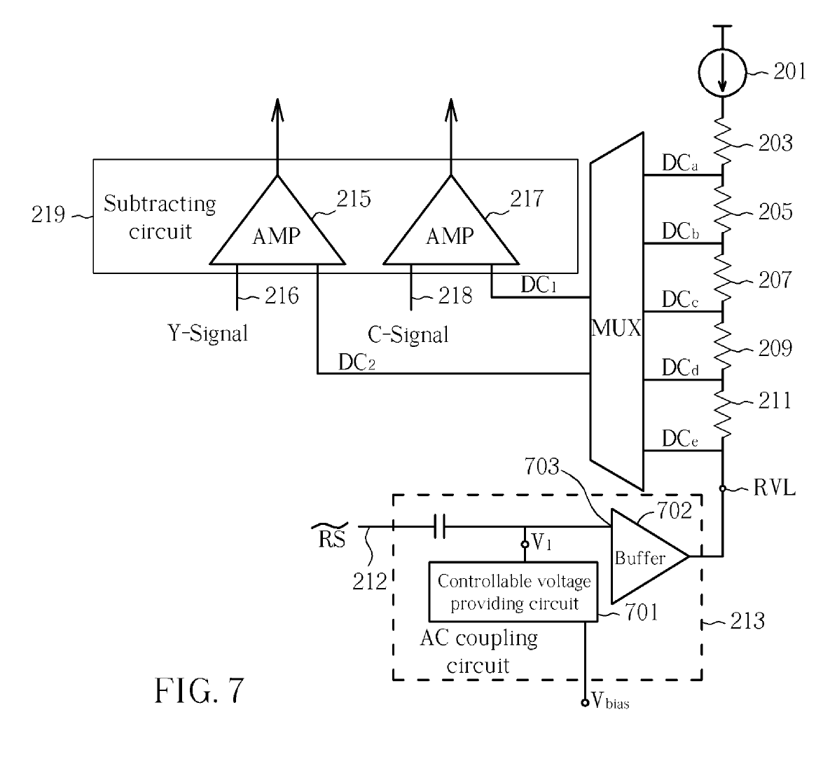

FIG. 7 is a circuit diagram illustrating a fourth embodiment of the AC coupling circuit 213 shown in FIG. 2 and FIG. 3. In this case, a controllable voltage providing circuit 701 is used for providing a voltage level V₁ at an input 703 of a buffer 702. The controllable voltage providing circuit 701 is coupled between the input 703 of the buffer 702 and a bias voltage level V_{bias}.

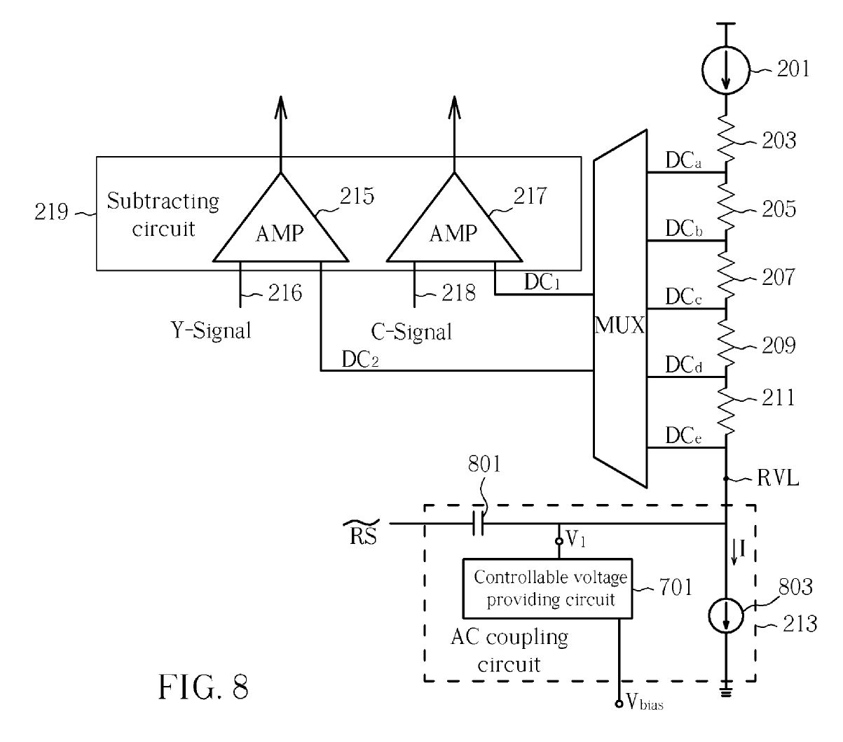

FIG. 8 is a circuit diagram illustrating the fifth embodiment of the AC coupling circuit 213 shown in FIG. 2 and FIG. 3. Similarly, a controllable voltage providing circuit 701 is used for providing a voltage level V₁. According to this circuit, the reference voltage level RVL is determined by the current I provided by the current source 803 and the values of voltage level V₁. Specifically, the capacitor 801 has a first electrode and a second electrode, and the first electrode is arranged to couple the reference ground signal RS to generate the reference voltage level RVL on the second electrode. Also, the controllable voltage providing circuit 701 is coupled between a bias voltage level V_{bias} and the second electrode of the capacitor 801 for modifying the first and second voltage levels DC₁ and DC₂.

The circuit shown in FIG. 7 utilizes the voltage level V₁ to adjust the reference ground signal RS ac-coupled from the capacitor, and then the adjusted ac-coupled reference ground signal RS is inputted to the buffer 802 to generate the reference voltage level RVL. In another aspect, the circuit shown in FIG. 8 directly utilizes the voltage level V₁ to adjust the reference voltage level RVL. Therefore, the circuits shown in FIG. 7 and FIG. 8 have some differences in their circuit operations.

FIG. 9 is a circuit diagram illustrating an embodiment of the controllable voltage providing circuit 701 shown in FIG. 7 and FIG. 8. As shown in FIG. 9, the controllable voltage providing circuit 701 comprises a controllable current source 1001 and an amplifier 1005. In this case, the controllable current source 1001 is used for providing a source current. The amplifier 1005 comprises a first input 1009 and a second input 1011. The first input 1009 is coupled to the bias voltage level V_{bias}. The second input 1011 is coupled to the controllable current source 1001. The output 1013 of the amplifier 1005 is used for controlling the controllable current source 1001 by a comparing result of the bias voltage level V_{bias} and a voltage of the second input 1011. By this circuit, the voltage level V₁ shown in FIG. 7 and FIG. 8 can be generated at the second input 1011 of the amplifier 1005.

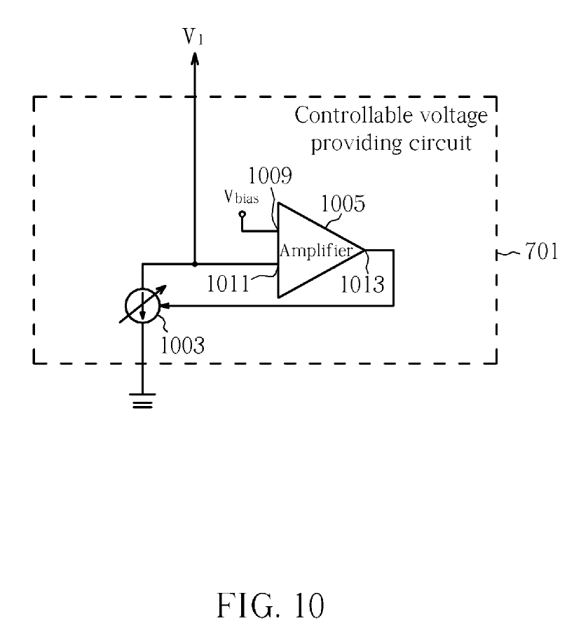

FIG. 10 is a circuit diagram illustrating another embodiment of the controllable voltage providing circuit 701 shown in FIG. 7 and FIG. 8. As shown in FIG. 10, the controllable voltage providing circuit 701 comprises a controllable current source 1003 and an amplifier 1005. In this case, the controllable current source 1003 is used for providing a sink current. The amplifier 1005 comprises a first input 1009 and a second input 1011. The first input 1009 is coupled to the bias voltage level V_{bias}. The second input 1011 is coupled to the controllable current source 1003. The output 1013 of the amplifier 1005 is used for controlling the controllable current source 1003 by a comparing result of the bias voltage level V_{bias} and a voltage of the second input 1011. By this circuit, the voltage level V₁ shown in FIG. 7 and FIG. 8 can be generated at the second input 1011 of the amplifier 1005.

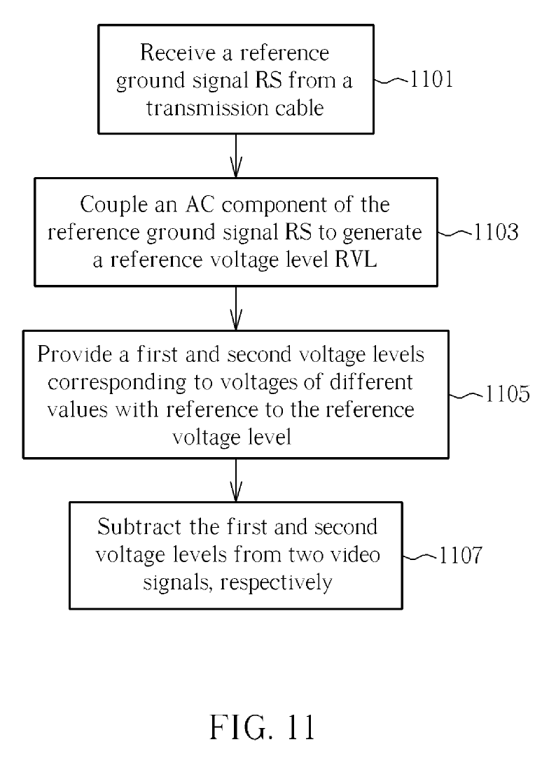

According abovementioned description, a method for reducing ground noise of video signals can be obtained, as shown in FIG. 11. The method includes the steps of:

### Step 1101

Receive a reference ground signal RS from a transmission cable. In this case, the reference ground signal RS will have AC component that causes noise of the ground level.

### Step 1103:

Couple the reference ground signal RS to generate a reference voltage level RVL.

### Step 1105

Provide a first and second voltage levels corresponding to voltages of different values with reference to the reference voltage level RVL. The first and second voltage levels can be directly obtained from the connection nodes of series-connected resistors 203-211, as illustrated in FIG. 2. Alternatively, the first and second voltage levels can be obtained by selecting two required voltage levels from a plurality of candidate voltage levels provided by the connection nodes of series-connected resistors 203-211, as illustrated in FIG. 3.

### Step 1107

Subtract the first and second DC voltage levels from two video signals, such as TV signals, respectively.

Other detail characteristics of the method for reducing ground noise of video signals can be obtained from above-mentioned description, thus it is omitted for brevity.

According to the above-mentioned embodiments, correct voltage levels can be provided to different video signals respectively, and the ground AC signal can be reserved. The error due to the noise of a ground signal can thereby be canceled.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for reducing ground noise of video signals, comprising:
a current source;
a plurality of resistors, coupled in series between the current source and a reference voltage level, for outputting a first and second voltage levels corresponding to different voltages provided by the series-connected resistors;
an AC coupling circuit for receiving a reference ground signal and coupling an AC component of the reference ground signal to generate the reference voltage level; and
a subtracting circuit for subtracting the first and second voltage levels from two video signals, respectively.

2. The circuit of claim 1, wherein the subtracting circuit comprises two amplifiers each having two inputs coupled to the corresponding voltage level and one of the video signals, respectively.

3. The circuit of claim 1, wherein the AC coupling circuit comprises:
a capacitor, coupled between the reference voltage level and the reference ground signal; and
a resistor, coupled between the reference voltage level and a predetermined voltage level.

4. The circuit of claim 3, wherein the predetermined voltage level is a ground level or a bias voltage level.

5. The circuit of claim 3, wherein the AC coupling circuit further comprises a current source coupled in parallel to the resistor of the AC coupling circuit.

6. The circuit of claim 1, wherein the AC coupling circuit comprises:
a buffer, having an output to generate the reference voltage level;
a capacitor, coupled between an input of the buffer and the reference ground signal; and
a resistor, coupled between the input of the buffer and a predetermined voltage level.

7. The circuit of claim 1, wherein the AC coupling circuit comprises:
a buffer, having an output to generate the reference voltage level;
a capacitor, coupled between the reference ground signal and an input of the buffer; and
a controllable voltage providing circuit, coupled between the input of the buffer and a bias voltage level, for providing a voltage level to the input of the buffer.

8. The receiving circuit of claim 7, wherein the controllable voltage providing circuit comprises:
a controllable current source; and
an amplifier, comprising a first input coupled to the bias voltage level, a second input coupled to the controllable current source, and an output for controlling the controllable current source by a comparing result of the bias voltage level and a voltage of the second input, wherein the voltage of the second input is served as the voltage level provided to the input of the buffer.

9. The circuit of claim 1, wherein the AC coupling circuit comprises:
a capacitor having a first electrode and a second electrode, wherein the first electrode is arranged to couple the reference ground signal to generate the reference voltage level on the second electrode;
a current source, coupled between the reference voltage level and a ground level; and
a controllable voltage providing circuit, coupled between a bias voltage level and the second electrode of the capacitor, for modifying the first and second voltage levels.

10. The circuit of claim 9, wherein the controllable voltage providing circuit comprises:
a controllable current source; and
an amplifier, comprising a first input coupled to the bias voltage level, a second input coupled to the controllable current source, and an output for controlling the controllable current source by a comparing result of the bias voltage level and a voltage of the second input, wherein the controllable voltage providing circuit is arranged to modify the first and second voltage levels with the voltage of the second input.

11. The circuit of claim 1, further comprising:
a multiplexer for selecting the first and second voltage levels from voltages provided by the series-connected resistors for the subtracting circuit.

12. A method for reducing ground noise of video signals, comprising: receiving a reference ground signal;
coupling an AC component of the reference ground signal to generate a reference voltage level;
providing a first and second voltage levels corresponding to voltages of different values generated with reference to the reference voltage level; and
subtracting the first and second voltage levels from two video signals to obtain two subtracted video signals, respectively.

13. The method of claim 12, wherein the step of subtracting the first and second voltage levels from two video signals utilizes at least one amplifier.

14. The method of claim 12, wherein the step of coupling an AC component of the reference ground signal to generate a reference voltage level utilizes an AC coupling circuit comprising:
a capacitor, coupled between the reference voltage level and the reference ground signal; and
a resistor, coupled between the reference voltage level and a predetermined voltage level.

15. The method of claim 14, wherein the predetermined voltage level is a ground level or a bias voltage level.

16. The method of claim 12, wherein the step of coupling an AC component of the reference ground signal to generate a reference voltage level utilizes an AC coupling circuit comprising:
a buffer, having an output to generate the reference voltage level;
a capacitor, coupled between the reference ground signal and an input of the buffer; and
a controllable voltage providing circuit, coupled between the input of the buffer and a bias voltage level, for providing a voltage level to the input of the buffer.

17. The method of claim 12, wherein the step of coupling an AC component of the reference ground signal to generate a reference voltage level utilizes an AC coupling circuit comprising:
a capacitor having a first electrode and a second electrode, wherein the first electrode is arranged to couple the reference ground signal to generate the reference voltage level on the second electrode;
a current source, coupled between the reference voltage level and a ground level; and
a controllable voltage providing circuit, coupled between a bias voltage level and the second electrode of the capacitor, for modifying the first and second voltage levels.

18. The method of claim 12, wherein the step of providing a first and second voltage levels comprises:
selecting the first and second voltage levels from voltages generated by a plurality of resistors coupled in series between a current source and the reference voltage level.
